(19) United States
(12) Patent Application Publication
(10) Pub. No.: US 2005/0107071 A1
(43) Pub. Date: May 19, 2005

(54) Method and apparatus for a network-based voice memo feature

(76) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114, US

(21) Appl. No.: 10/715,010

(22) Filed: Nov. 17, 2003

(51) Int. Cl. H04M 11/00; H04M 11/10

(52) U.S. Cl. 455/413; 455/412.1; 379/88.16

(57) ABSTRACT

This invention relates to a method and apparatus forproviding a network-based voice memo feature. More particularly, the invention is directed to a system that will provide network-based functionality to allow a user to record a voice memo during an ongoing call, create a voice mail message based on the recorded memo and store the message in the users voice mail box for later retrieval. In one form, mobile subscribers are able to conveniently record short voice memos, such as those relating to directory assistance, driving directions, . . . etc., while on a call and retrieve the recorded information when needed.

### BACKGROUND OF THE INVENTION

This invention relates to a method and apparatus forproviding a network-based voice memo feature. More particularly, the invention is directed to a system that will provide network-based functionality to allow a user to record a voice memo during an ongoing call, create a voice mail message based on the recorded memo and store the message in the user's voice mail box for later retrieval. In one form, mobile subscribers are able to conveniently record short voice memos, such as those relating to directory assistance, driving directions, . . . etc., while on a call and retrieve the recorded information when needed.

While the invention is particularly directed to the art of network supported voice memo features, and will be thus described with specific reference thereto, it will be appreciated that the invention may have usefulness in other fields and applications. For example, the invention may be used to support other network-based features where recording during the duration of a call is desired.

By way of background, it is not uncommon for wireless phone users to desire to use their mobile handset as a recording device to leave themselves a voice memo for later retrieval. These circumstances oftentimes arise when a mobile subscriber is driving, or engaging in activities making it otherwise inconvenient to write notes or perform data entry. For example, a user may call directory assistance and wish to record the phone number that is being conveyed to the user by the directory assistance operator. As a further example, the user may wish to record driving directions that it receives from another user on a call but is not in a position to write the directions down or remember the directions for later recording.

Presently, wireless service providers provide the capability to record a voice memo directly on a handset. However, there are three primary difficulties with this approach. First, several menus are typically provided to the actual mobile phone to implement this procedure. It is inconvenient to navigate through these menus on the handset to perform recording/playing functions such as select, play and delete. Second, this known approach does not work when the mobile phone is engaged on an actual call. As such, a caller is not able to record information while speaking with another caller. Last, this known technique does not allow for a reminder to prompt the mobile subscriber to retrieve the voice memo at a later time. As such, valuable information is oftentimes not accessed in a timely manner and, thus, rendered useless.

The present invention contemplates a network-based voice memo feature that resolves the above-referenced difficulties and others.

### SUMMARY OF THE INVENTION

A method and apparatus for a network-based voice memo feature are provided.

In one aspect of the invention, a system comprises a voice messaging system, a switching component operative to maintain a voice call between a mobile station and another communication device, the voice call having a forward link and reverse link, and a control module within the switching component operative to 1) monitor the reverse link of the voice call, 2) detect a first code transmitted on the reverse link by the mobile station, 3) open a connection between the mobile station and the voice messaging system based on the first code, wherein the voice messaging system is operative to record voice data transmitted on the reverse link subsequent to the detection of the first code through the opened connection, 4) detect a second code transmitted on the reverse link by the mobile station and 5) terminate the connection between the mobile station and the voice messaging system based on the second code.

In another aspect of the invention, the control module is operative to validate the mobile station.

In another aspect of the invention, the control module is operative to identify the recorded voice data as a voice mail message to be stored in a voice mail box of a user of the mobile station.

In another aspect of the invention, the control module is operative to identify the recorded voice data as a recorded memo to be stored in a voice mail box of a user of the mobile station.

In another aspect of the invention, the connection comprises a first path from the mobile station to the control module and a second path from the control module to a speech handler.

In another aspect of the invention, a system comprises a means for maintaining a voice call having a forward link and a reverse link, the voice call occurring between a mobile station and another communication device, means for monitoring the reverse link of the voice call, means for detecting a first code transmitted on the reverse link by the mobile station, means for opening a connection between the mobile station and a voice messaging system based on the first code, means for recording voice data transmitted on the reverse link subsequent to the detection of the first code on the voice messaging system through the opened connection, means for detecting a second code transmitted on the reverse link by the mobile station and means for terminating the connection between the mobile station and the voice messaging system based on the second code.

In another aspect of the invention, the system comprises means for validating the mobile station.

In another aspect of the invention, the system comprises means for identifying the recorded voice data as a voice mail message to be stored in a voice mail box of a user of the mobile station.

In another aspect of the invention, the system comprises means for identifying the recorded voice data as a recorded memo to be stored in a voice mail box of a user of the mobile station.

In another aspect of the invention, the system comprises a first path for the mobile station to a voice memo control module and a second path from a voice memo control module to a voice handler.

In another aspect of the invention, a method comprises maintaining a voice call between a mobile station and another communication device, the voice call having a forward link and a reverse link, monitoring the reverse link of the voice call, detecting a first code transmitted on the reverse link by the mobile station, opening a connection between the mobile station and a voice messaging system based on the first code, recording voice data transmitted on the reverse link subsequent to the detection of the first code on the voice messaging system through the opened connection, detecting a second code transmitted on the reverse link by the mobile station and terminating the connection between the mobile station and the voice messaging system based on the second code.

In another aspect of the invention, the method comprises validating the mobile station.

In another aspect of the invention, the method comprises identifying the recorded voice data as a voice mail message to be stored in a voice mail box of a user of the mobile station.

In another aspect of the invention, the method comprises identifying the recorded voice data as a recorded memo to be stored in a voice mail box of a user of the mobile station.

In another aspect of the invention, the method comprises opening the connection between the mobile station and the voice messaging system through a voice memo control module and a voice handler.

An advantage to the present invention is that many layers of menus for navigation on the mobile phone are not required to retrieve and administer voice memos.

Another advantage of the invention is that subscribers are notified of a voice memo in the same manner as voice mail notification. In this way, voice memos are not rendered useless by being inadvertently forgotten.

Still another advantage of the invention is that it allows the mobile subscriber to record information while being engaged in a live call, as opposed to relying on memory and rerecording using known mobile voice memo technology.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a graphic illustration of an example network into which the present invention may be implemented;

FIG. 2 is a graphic representation of a mobile subscriber database according to the present invention;

FIG. 3 is an exemplary mobile switching center according to the present invention;

FIG. 4 is an illustration of an example of a mobile phone modified according to the present invention;

FIG. 5 is a flow chart illustrating a method according to the present invention;

FIG. 6 is a call flow, or sequence diagram according to the present invention; and,

FIG. 7 is an example of a voice messaging system modified according to one of the embodiments of the present invention.

### DETAILED DESCRIPTION OF THE PREFERRED EMBODIMENTS

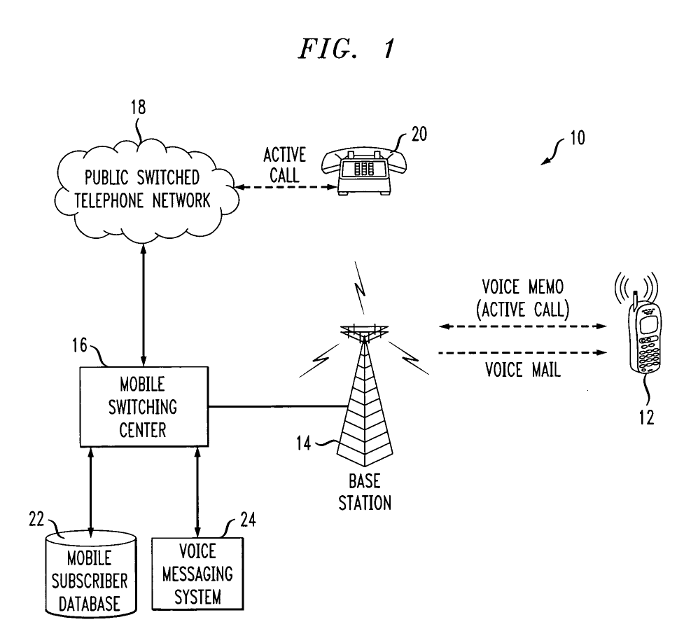

Referring now to the drawings wherein the showings are for purposes of illustrating the preferred embodiments of the invention only and not for purposes of limiting same, FIG. 1 provides a view of a network into which the present invention may be implemented. As shown, a network 10 is operative to communicate with a mobile station 12. The mobile station 12 communicates to the network 10 through base station 14 which is connected to mobile switching center (MSC) 16. The mobile switching center (MSC) 16 can be linked to a variety of networks and/or network components. As illustrated, the mobile switching center 16 is in communication with a public switched telephone network (PSTN) 18 which allows for communication to a variety of devices including telephone 20.

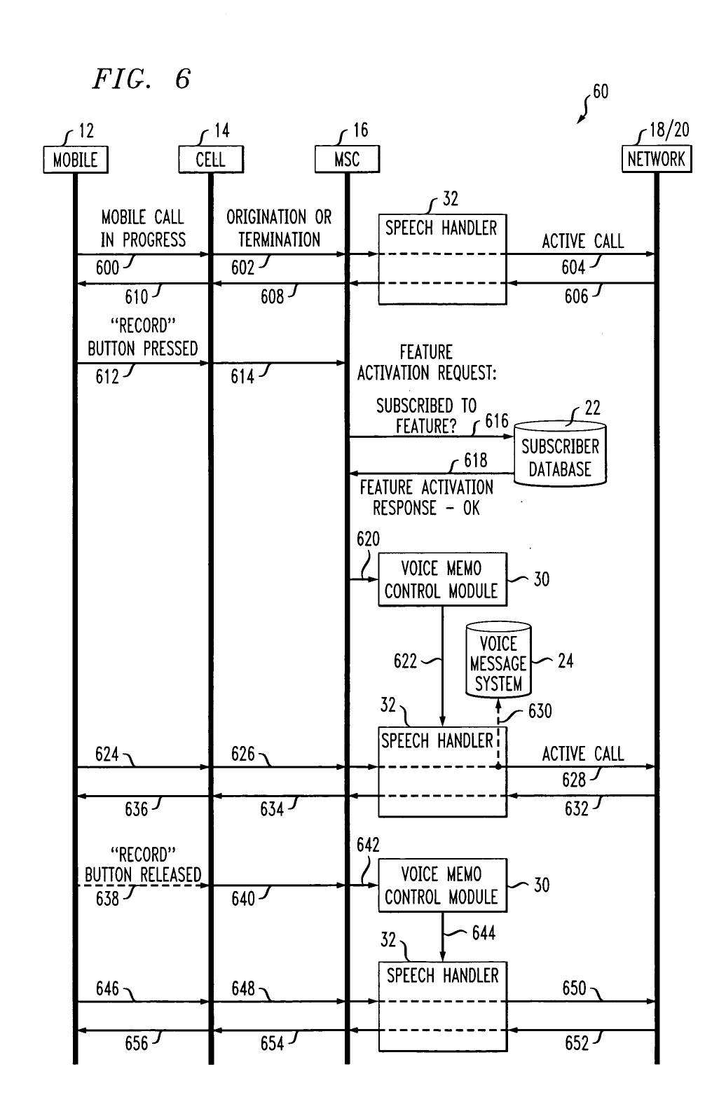

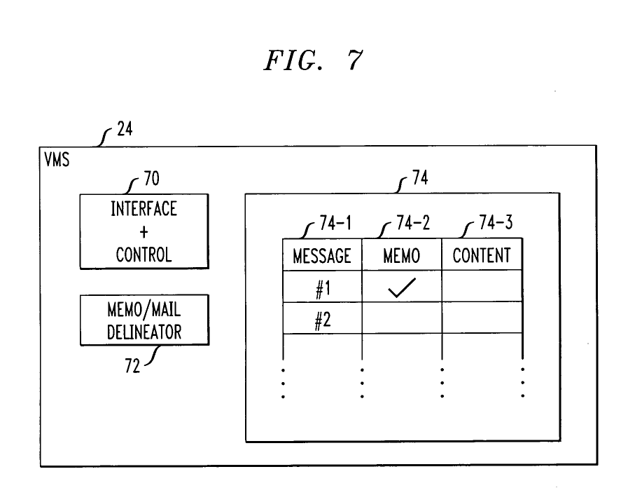

It is to be understood that active calls exist in known wireless network structures as having a forward link and a reverse link, examples of which are illustrated in FIG. 6 to be described hereafter. The forward link is the channel that accommodates voice data received by a particular mobile phone. A reverse link is the channel upon which data is transmitted from a particular mobile phone. For ease of reference, this reference convention will be maintained in this description.

Implementation of the present invention allows for the mobile station 12 to carry on an active call with another communication device, e.g., phone 20, and, while the call remains active, record a voice memo on the voice messaging system which can be later retrieved as a voice mail message. The user can initiate recording by pressing a button (or using other techniques) as will be described and can stop the recording by pushing the button a second time or releasing the button. The manipulation of buttons results in codes or signals being transmitted from the mobile station to the network. In this way, the deficiencies of the prior system are overcome. Specifically, users are able to conveniently record a voice memo during an active call and to later retrieve the message or voice memo in a timely manner (because it is treated in the network as a voice mail message).

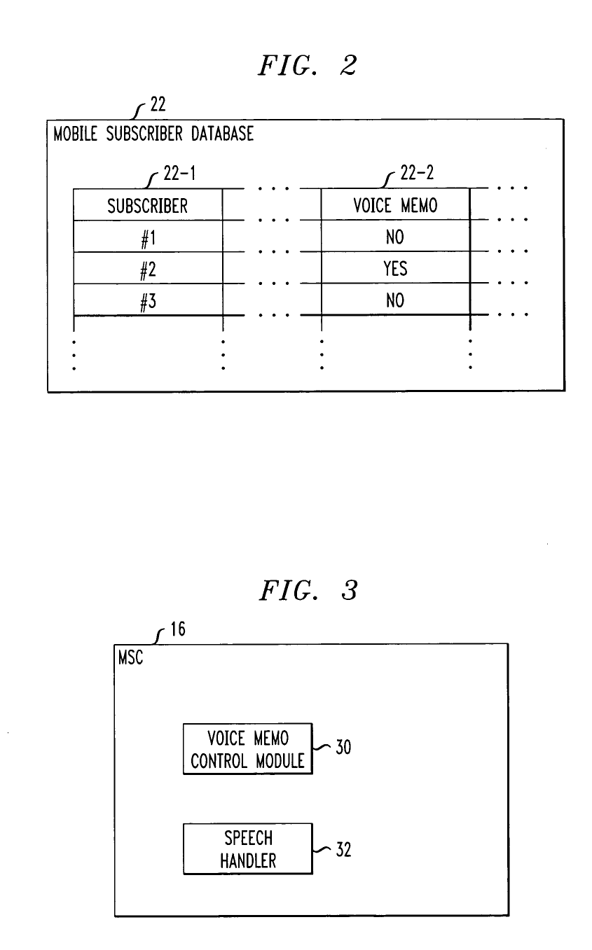

To implement the invention, the network is modified to accommodate the functionality contemplated thereby. Referring now to FIG. 2, the mobile subscriber database 22 is illustrated. It is to be appreciated that the mobile subscriber database 22 includes a variety of categories of information that are not shown. However, for purposes of this invention, the mobile subscriber database includes a subscriber identification field 22-1 and a subscriber data field 22-2. As is apparent from FIG. 2, the subscriber identification field 22-1 simply lists subscribers by identification number or other information, as is well known in the industry. The subscriber data field 22-2 is a field provided in addition to that which is typically provided and contains information indicating whether a particular subscriber does indeed subscribe to the voice memo feature contemplated by the present invention. As shown, subscriber #1 and subscriber #3 do not subscribe to the voice memo feature. However, subscriber #2 does subscribe to the voice memo feature.

It should be understood that the form of the data shown is merely representative. The actual data may take a variety of forms in a variety of formats that will be apparent to those of skill in the art. For example, subscriber data field 22-2 as shown illustrates data entries of “YES” and “NO.” These data entries could alternatively be “ones” and “zeros” or “set” data and “reset” data.

Referring now to FIG. 3, the mobile switching center (MSC) 16 according to the present invention is illustrated. It should be appreciated that a mobile switching center (MSC) 16 performs a variety of functions that are well known in the art. This well known functionality is not illustrated for purposes of explaining the present invention. The components illustrated are those which are those specifically implemented to provide the functionality of the present invention. For example, a voice memo control module 30 and a speech handler 32 are included in the mobile switching center (MSC) 16. It should be further understood that a mobile switching center is shown as an example of a switching component of a network. However, in the absence of a mobile switching center within a network, other components that handle switching functionalities could likewise be used to implement the invention.

According to the present invention, the control module 30 performs a variety of functions such as monitoring the reverse link of a voice call, detecting a first code or signal transmitted on the reverse link by the mobile station, opening a connection between the mobile station and the voice messaging system based on detection of the first code so that voice data can be recorded on the voice messaging system, detecting a second code or signal transmitted on the reverse link by the mobile station, and terminating the connection between the mobile station and the voice messaging system based on detection of the second code. The control module 30 may also be operative to validate the mobile station. That is, the control module 30 is also operative to access the mobile subscriber database 22 to determine if the subscriber subscribes to the voice memo feature, as will be indicated by the subscriber data field 22-2 (shown in FIG. 2).

The speech handler 32 is a voice encoding module that is useful in implementation of voice message systems. It encodes the received voice data so that it can be properly stored and retrieved. Speech handlers are well known in the art.

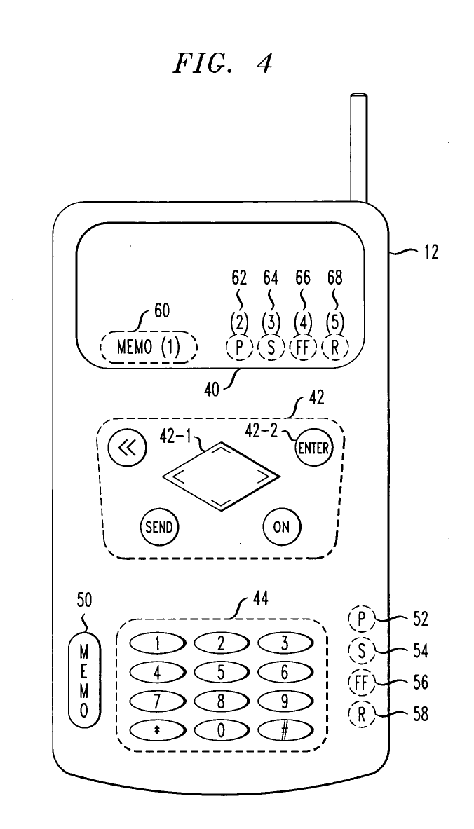

Referring now to FIG. 4, an example of a mobile phone according to the present invention is illustrated. Although a mobile phone is illustrated, it should be appreciated that other mobile communication devices such as personal digital assistants (PDAs) may also be used.

As illustrated, a mobile phone 12 is shown as having a display 40, control function keys or keypad 42, and dialing function keypad 44. Also shown in the illustration are a memo button 50 which can be used to send codes or signals to the mobile switching center (MSC) 16, as described above, to initiate the functionality of the voice memo feature according to the present invention. The code or signals implemented according to the present invention take a form that is compatible with the communication protocol being used and are transmitted over the reverse link of the call in a manner so as to maintain the call. Appropriate hardware or software used for signaling within the mobile station 12 is preferably used and/or adapted to be used to respond to manipulation of the button 50 (as well as other buttons or keys contemplated herein, whether hard keys or soft keys). As illustrated, the memo button 50 is a hard key that is easily accessible by the user of the mobile station 12. The reason for this ease of accessibility is to allow the user to access the voice memo feature without interrupting the ongoing call that is occurring. Unnecessary manipulation of keys or menus is thus avoided using this configuration.

Also shown in FIG. 4 are a variety of other hard keys and soft keys. For example, a mobile station 12 may also be provided with the following hard keys to make use of the present invention: play button 52, stop button 54, fast forward button 56 and rewind button 58. These buttons are useful for recording or playing back voice memos, and could likewise be used for the voice messaging system. Of course, it should be appreciated that this functionality could be implemented through the use of numeric codes, such as those that are currently used in voice messaging systems that are well known in the art.

As an alternative to the hard keys 50 through 58, soft keys 60 through 68 could be implemented. Of course, soft keys are less desirable because they require the user to engage in increased manipulation of the control function keypad 42 and/or the dialing keypad 44. Nonetheless, soft keys could be provided on the display 40. In this regard, a memo key 60, a play key 62, a stop key 64, a fast forward key 66, and a rewind key 68 may be displayed on the monitor 40 and selected using the control function keypad 42 and/or the numeric keypad 44. For example, a navigation button 42-1 could be used to navigate to the “soft” memo button 60, then an “enter” button 42-2 could be pressed to select the memo feature. The keys 62-68 could be likewise selected.

As an alternative, numeric codes could be used once the soft keys are displayed. In this regard, numeric code 1 from dialing keypad 44 could be used to select the memo button 60. Likewise, the keys 62 through 66 could be selected using the numeric buttons 2-5 of the dialing keypad 44. Of course, it should be appreciated that the mobile station 12 illustrated in FIG. 4 is merely an example of modifications that may be implemented to realize the present invention. For example, menus could be downloaded to the mobile station 12 and used in conjunction with soft keys and/or navigation techniques so that no physical modification to the mobile station is required. However, use of menus and multiple soft keys is less desirable because any implementation short of a single hard key or soft key activation requires increased manipulation of the keys and/or layers of menus.

It should be understood that manipulation of the memo key, whether a hard key or soft key, results in the transmission of a code or signal to the network from the mobile station 12. Again, the code may take a form compatible with the communication protocol being used and is transmitted on the reverse link. This code is ultimately recognized by the network as being a memo feature initiation code to commence recording of subsequent voice data that is transmitted from the user through the mobile station. Preferably, the network monitors the reverse link of the ongoing call to recognize the codes transmitted from the mobile station 12 and capture the voice data of the user of the mobile station 12. Once the user decides to terminate the recording, a second code must be transmitted by the mobile station 12 to the network. This can be accomplished by pressing the same memo button a second time or, in some embodiments, may comprise releasing the button which may have been depressed for the entire duration of the recording. A separate stop key may also be provided. In any circumstance, the mobile station must function to provide signaling to the network that recording should begin at a particular point and that the recording should end at another point in time. This, of course, can be accomplished in a variety of manners, including those contemplated herein.

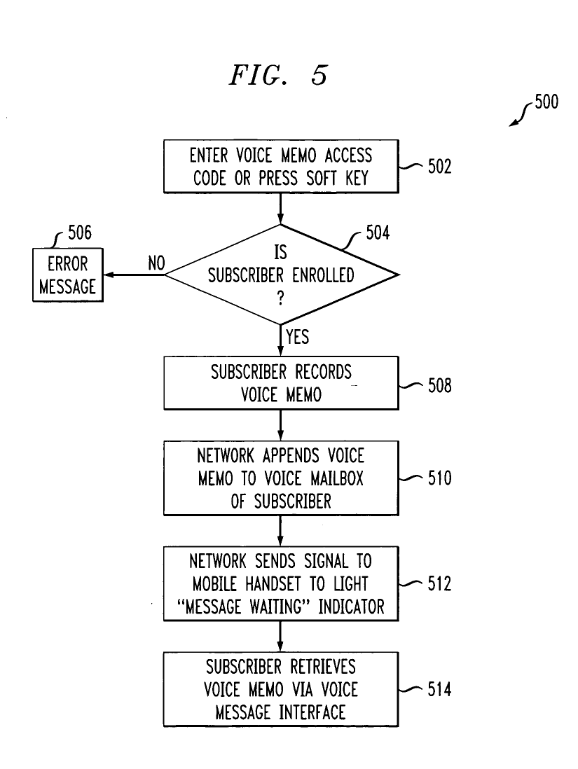

Referring now to FIG. 5, a method according to the present invention is illustrated. It will be appreciated by those of skill in the art that the methods and techniques of the present invention can be implemented using a variety of software and hardware techniques. Software algorithms contemplated by the present invention are controlled by and may well be stored within the mobile switching center (MSC) 16 in the form of, for example, the voice memo control module 30. Of course, it is this combination of hardware and software that provides the means for implementation of the invention.

As shown, method 500 begins with the transmission of a code from the mobile station to the network on the reverse link of an ongoing call (step 502). This code could be sent from the mobile station as described in connection with FIG. 4. For example, it may be transmitted upon depression of a key. Next, the control module 30 of the mobile switching center (MSC) 16 detects the code on the reverse link of the call and determines, through access to the mobile subscriber database 22, whether the subscriber is enrolled in the voice memo feature program (step 504). This is accomplished by accessing the subscriber data field 22-2 of the mobile subscriber database 22. If it is determined that the user is not a valid subscriber, then an error message is sent back to the user (step 506). However, if the subscriber is a valid subscriber then, based on the detected code, the control module opens a connection between the mobile station and the voice messaging system in such a way so as to allow the voice messaging system to record voice data that is transmitted from that point in time forward (step 508). The opening of this connection is accomplished in manners consistent with the opening of a connection to allow a caller to leave a voice mail message for a called party. To implement the invention, the connection is opened between the mobile station and the voice messaging system on a path through the voice memo control module and a voice handler. When the recording is complete, it should be understood that the user manipulates the memo button, or otherwise sends a code, back to the mobile switching center (MSC) 16 to indicate that there is no longer a desire to record. The control module 30 then detects this second code or signal (or absence of a code or signal) and terminates the connection between the mobile station and the voice messaging system, thus terminating the recording. However, the voice call is maintained (assuming the users maintain the call). The network then appends the recorded voice data as a voice memo to the voice mail box of the subscriber (step 510). As would be the case with all voice mail messages, the networkthen sends a signal to the mobile handset, or station 12, to light a “message waiting” indicator (step 512). The subscriber can then retrieve the voice memo via a voice message interface provided by the voice messaging system (step 514).

Referring now to FIG. 6, an example call flow, or sequence, diagram 600 is illustrated. As mentioned previously, the implementation of the present invention allows for an ongoing active call to be maintained by the mobile switching center (MSC) 16 while the voice memo feature is initiated. As such, the call flow diagram 60 shows the typical call flow for an active call. In this regard, a mobile station 12 communicates through a cell site 14 and then to a mobile switching center (MSC) 16 as shown at lines 600 and 602. A speech handler 32 is implemented by the mobile switching center (MSC) 16 to transmit the active call to the network, such as the public switched telephone network (PSTN) 18 and/or communication device 20, as shown at line 604. The path defined by that which is shown at lines 600, 602 and 604 is referred to as a reverse link. During such a call, there is a communication path (i.e., a forward link) established from the network back to the mobile 12, as shown at line 606, 608 and 610. During the call, when a user desires to initiate the voice memo feature, the memo button is pressed and the code is sent from the mobile station to the cell site 14, as shown at line 612. This code is then transmitted to the mobile switching center (MSC) 16, as shown at line 614, and the mobile switching center (MSC) 16 determines whether the user is a valid subscriber to the voice memo feature. This determination is made by accessing subscriber database 22 and reading the subscriber data field 22-2, shown at line 616. The results of this access to the database 22 are then sent back to the mobile switching center (MSC) 16, as shown at line 618. If the user is a valid user, this information is provided to the control module 30 (such as at line 620), and the control module 30 accesses the speech handler 32, as shown at line 622. The control module 30 then sets up a path between the mobile station 12 and a voice message system 24 so that when subsequent voice data is received by the mobile switching center (MSC) 16, such as shown at lines 624 and 626, the voice data is provided to the network 18 (and phone 20), as well as the voice message system 24, as shown at lines 628 and 630. Of course, a forward link from the network back to the mobile station is not impacted, as shown at lines 632, 634 and 636.

Once the user decides that recording is no longer necessary, the record button is released (or depressed a second time) and a second code is sent from the mobile station to a cell and then on to the mobile switching center (MSC) 16, as shown at lines 638 and 640. Upon recognition by the voice control module 30 of the second code, the connection between the voice message system and the mobile station is terminated (in a manner similar to terminating a connection for a conventional voice mail message) but the voice call is maintained. Accordingly, the typical paths for an active call are resumed, as shown at lines 646, 648, 650, 652, 654 and 656. The recorded voice data is then recognized by the voice messaging system as a voice mail message to be stored in the inbox of the user. Of course, the voice messaging system provides a visual reminder to the user on the display of the mobile station, in a manner similar to that involving voice mail messages.

In a variation of the implementation of the present invention, the system may provide an indication to the user as to whether the message stored in its voice mail box is a “memo” or an actual voice mail message. To realize such a system, the voice message system is preferably modified. Referring now to FIG. 7, a voice message system 24 is illustrated. Of course, the voice messaging system 24 performs a variety of functions that are well known in the art and are not described herein. However, for purposes of explaining the invention, the voice messaging system 24 will include an interface and control module 70, a memo/mail delineater 72, and a message storage module 74. As is illustrated, the storage module 74 includes a field 74-1 for identifying each message, a delineation field 74-2—which indicates whether the message is a memo or a voice mail, and a content data field 74-3 which includes the content of the message, whether it is a memo or a voice mail.

Modification of the voice messaging system 24 will allow the user to record voice memos and consequently have an ability to efficiently determine whether the information stored in its voice mail box is a voice memo or an actual voice mail message. This is accomplished using the voice messaging system of FIG. 7 by providing for an interface and control module which tags each recorded memo. This tag is then stored as data field 74-2, as shown in FIG. 7. The tag is based on signaling from the mobile switching center (MSC) 16 prompted by the code received by the mobile switching center (MSC) 16 upon initiation of a recording session by the mobile user. The data field 74-2 is then utilized by the voice messaging system (e.g., memo/mail delineator 72) to display different icons on the display of the appropriate mobile station indicating whether the stored data is a memo or a voice mail message.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method for supporting a network-based voice memo feature comprising:
maintaining a voice call between a mobile station and another communication device, the voice call having a forward link and reverse link;
monitoring the reverse link of the voice call;
detecting a first code transmitted on the reverse link by the mobile station;
opening a connection between the mobile station and a voice messaging system based on the first code;
recording voice data transmitted on the reverse link subsequent to the detection of the first code on the voice messaging system through the opened connection;
detecting a second code transmitted on the reverse link by the mobile station; and,
terminating the connection between the mobile station and the voice messaging system based on the second code.

2. The method as set forth in claim 1 further comprising validating the mobile station.

3. The method as set forth in claim 1 further comprising identifying the recorded voice data as a voice mail message to be stored in a voice mailbox of a user of the mobile station.

4. The method as set forth in claim 1 further comprising identifying the recorded voice data as a recorded memo to be stored in a voice mailbox of a user of the mobile station.

5. The method as set forth in claim 1 wherein the opening of the connection comprises opening the connection between the mobile station and the voice messaging system through a voice memo control module and a voice handler.

6. A system for network-based voice memo feature comprising:
means for maintaining a voice call, the voice call having a forward link and reverse link between a mobile station and another communication device;
means for monitoring the reverse link of the voice call;
means for detecting a first code transmitted on the reverse link by the mobile station;
means for opening a connection between the mobile station and a voice messaging system based on the first code;
means for recording voice data transmitted on the reverse link subsequent to the detection of the first code on the voice messaging system through the opened connection;
means for detecting a second code transmitted on the reverse link by the mobile station; and,
means for terminating the connection between the mobile station and the voice messaging system based on the second code.

7. The system as set forth in claim 6 further comprising means for validating the mobile station.

8. The system as set forth in claim 6 further comprising means for identifying the recorded voice data as a voice mail message to be stored in a voice mailbox of a user of the mobile station.

9. The system as set forth in claim 6 further comprising means for identifying the recorded voice data as a recorded memo to be stored in a voice mailbox of a user of the mobile station.

10. The system as set forth in claim 6 wherein the connection comprises a first path from the mobile station to a voice memo control module and a second path from the voice memo control module to a voice handler.

11. A system for a network-based voice memo feature comprising:
a voice messaging system;
a switching component operative to maintain a voice call between a mobile station and another communication device, the voice call having a forward link and reverse link;
a control module within the switching component operative to 1) monitor the reverse link of the voice call, 2) detect a first code transmitted on the reverse link by the mobile station, 3) open a connection between the mobile station and the voice messaging system based on the first code, wherein the voice messaging system is operative to record voice data transmitted on the reverse link subsequent to the detection of the first code through the opened connection, 4) detect a second code transmitted on the reverse link by the mobile station, and 5) terminate the connection between the mobile station and the voice messaging system based on the second code.

12. The system as set forth in claim 11 wherein the control module is operative to validate the mobile station.

13. The system as set forth in claim 11 wherein the control module is further operative to identify the recorded voice data as a voice mail message to be stored in a voice mailbox of a user of the mobile station.

14. The system as set forth in claim 11 wherein the control module is further operative to identify the recorded voice data as a recorded memo to be stored in the a voice mailbox of a user of the mobile station.

15. The system as set forth in claim 11 wherein the connection comprises a first path from the mobile station to the control module and a second path from the control module to a voice handler.
